(19) United States
(12) Patent Application Publication
(10) Pub. No.: US 2026/0094738 A1
(43) Pub. Date: Apr. 2, 2026

(54) INSULATED WIRE, CABLE, METHOD FOR MANUFACTURING INSULATED WIRE, AND CONNECTION STRUCTURE

(71) Applicant: Proterial, Ltd., Tokyo (JP)

(72) Inventors: Kenta KIMURA, Tokyo (JP); Masamichi IDONUMA, Tokyo (JP); Takanobu WATANABE, Tokyo (JP); Detian HUANG, Tokyo (JP)

(21) Appl. No.: 19/342,114

(22) Filed: Sep. 26, 2025

(30) Foreign Application Priority Data
Oct. 2, 2024 (JP) 2024-173858

(51) Int. Cl. H01B 3/30; H01B 1/02; H01B 19/02

(52) U.S. Cl. CPC H01B 3/307; H01B 1/02; H01B 19/02

(57) ABSTRACT

An insulated wire includes a conductor, and an insulation including a fluorine rubber and directly or indirectly covering the conductor, wherein the insulation has a water content of 0.4 wt% or less.

### CROSS-REFERENCE TO RELATED APPLICATIONS

The present application is based on Japanese patent application No. 2024-173858 filed on October 2, 2024, the entire contents of which are incorporated herein by reference.

### TECHNICAL FIELD

The present invention relates to an insulated wire having a conductor directly or indirectly covered with an insulation, a cable having plural insulated wires, a method for manufacturing the insulated wire, and a connection structure using the insulated wire.

### BACKGROUND OF THE INVENTION

Some of the conventional cables used, e.g., in high-temperature environments such as vehicle engine compartments, have insulated wires in which a conductor is covered with an insulation made of a fluorine rubber which exhibits excellent heat resistance (see, e.g., Patent Literatures 1 and 2).

When manufacturing such insulated wires, a rubber material is extruded around the conductor, cross-linked, and then cooled. In the process of cross-linking the rubber material, the rubber material before cross-linking is continuously supplied together with the conductor into a cross-linking tube, and superheated steam is also supplied into the cross-linking tube, and the rubber material is cross-linked by direct exposure to the superheated steam.

### Citation List Patent Literature 1: JP2019-192567A

Patent Literature 2: JP2023-097077A

### SUMMARY OF THE INVENTION

When a thermal aging test is conducted on insulated wires manufactured as described above, there are cases where the elongation at break, which is one of the mechanical characteristics of the insulation, changes significantly before and after the thermal aging test. The present inventors conducted intensive research into the cause of this phenomenon and found that the changes in the amount of water contained in the insulation is related to the change in the elongation at break of the insulation, which led to the present invention. Accordingly, it is an object of the invention to suppress changes in elongation at break of an insulation of an insulated wire and thereby stabilize its characteristics.

To solve the above-mentioned problem, one aspect of the invention provides an insulated wire, comprising: a conductor; and an insulation comprising a fluorine rubber and directly or indirectly covering the conductor, wherein the insulation has a water content of 0.4 wt% or less.

To solve the above-mentioned problem, another aspect of the invention also provides a cable, comprising: a plurality of insulated wires collectively covered with a sheath, wherein the insulated wire comprises a conductor, and an insulation comprising a fluorine rubber and directly or indirectly covering the conductor, and wherein the insulation has a water content of 0.4 wt% or less.

To solve the above-mentioned problem, a still another aspect of the invention also provides a method for manufacturing an insulated wire that comprises a conductor and an insulation comprising a fluorine rubber and directly or indirectly covering the conductor, the method comprising: forming the insulation by extruding a rubber material around the conductor and cross-linking the rubber material; and drying the insulation formed in the forming the insulation so that the insulation has a water content of 0.4 wt% or less.

To solve the above-mentioned problem, a further aspect of the invention also provides a connection structure to connect between a pair of devices using the insulated wire described above, wherein at least one of the pair of devices is used in a high-temperature environment, wherein a terminal is fitted to the conductor at an end of the insulated wire, and wherein the terminal is connected to the at least one device.

To solve the above-mentioned problem, a still further aspect of the invention also provides a connection structure to connect between a pair of devices using the insulated wire described above, wherein the insulated wire is laid in an environment with exposure to high temperature, high radiation, high-temperature vapor, or involving immersion in cutting oil, wherein a terminal is fitted to the conductor at an end of the insulated wire, and wherein the terminal is connected to one of the pair of devices.

### Advantageous Effects of the Invention

According to the invention, it is possible to suppress changes in elongation at break of an insulation of an insulated wire and thereby stabilize its characteristics.

### BRIEF DESCRIPTION OF DRAWINGS

FIG. 1A is a perspective view showing a cable in the first embodiment of the present invention.

FIG. 1B is a cross-sectional view showing the cable taken along line A-A in FIG. 1A.

FIG. 2A is a perspective view showing one of three insulated wires.

FIG. 2B is a cross-sectional view showing the insulated wire taken along line B-B in FIG. 2A.

FIG. 3 is a schematic diagram illustrating an example configuration of a manufacturing device to form an insulation that covers a conductor together with a separator tape.

FIG. 4 is a graph showing an example of changes in the water content of the insulation of the insulated wire.

FIG. 5 is a graph showing an example of changes in the elongation of the insulation of the insulated wire.

FIG. 6 is a configuration diagram illustrating a connection structure connecting between a pair of devices using the insulated wires.

FIG. 7A is a perspective view showing the cable in the second embodiment of the invention.

FIG. 7B is a cross-sectional view showing the cable taken along line C-C in FIG. 7A.

FIG. 8 is a cross-sectional view showing a copper strand.

FIG. 9 is a configuration diagram illustrating a connection structure connecting between a pair of devices using the insulated wires.

FIG. 10 is a cross-sectional view showing a cable having insulated wires in a modification with the conductor configuration changed from the conductor of the insulated wire of the cable in the second embodiment.

### DETAILED DESCRIPTION OF THE INVENTION

### First embodiment

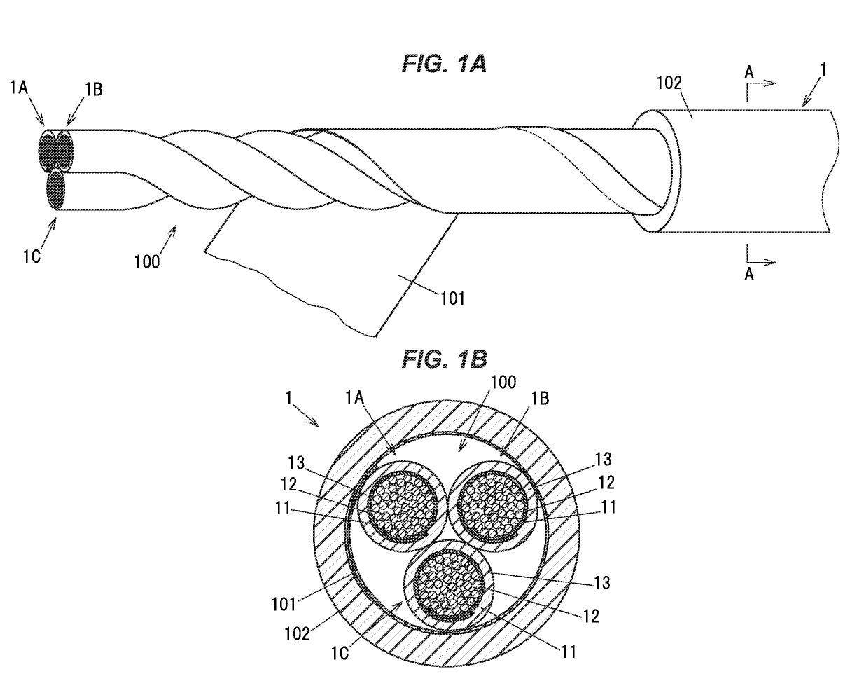

The first embodiment of the invention, which is a specific example of the present invention, will be described with reference to FIGS. 1A to 5. FIG. 1A is a perspective view showing a cable 1 in the first embodiment of the invention. FIG. 1B is a cross-sectional view showing the cable 1 taken along line A-A in FIG. 1A. This cable 1 is used, e.g., in a high-temperature environment such as vehicle engine compartment.

The cable 1 has a cable core 100 formed by twisting together plural insulated wires 1A, 1B, 1C, a tape member 101 spirally wrapped around the cable core 100, and a sheath 102 covering the outer circumference of the tape member 101. The tape member 101 can be, e.g., a strip-shaped member made of nonwoven fabric, paper, or resin. The sheath 102 is made of, e.g., an ethylene-propylene copolymer and collectively covers the plural insulated wires 1A, 1B, 1C. A filler made of, e.g., polypropylene yarn, spun rayon yarn (rayon staple fiber), aramid fiber, or nylon fiber, etc. may additionally be arranged around the insulated wires 1A, 1B, 1C.

In the first embodiment, the cable 1 has three insulated wires 1A, 1B, 1C. Each of the insulated wires 1A, 1B, 1C has a conductor 11, a separator layer 12, and an insulation 13 constituting the outermost insulating layer. The separator layer 12 is provided between the conductor 11 and the insulation 13. That is, in the first embodiment, the insulation 13 indirectly covers the conductor 11 through the separator layer 12 and is not in contact with the conductor 11.

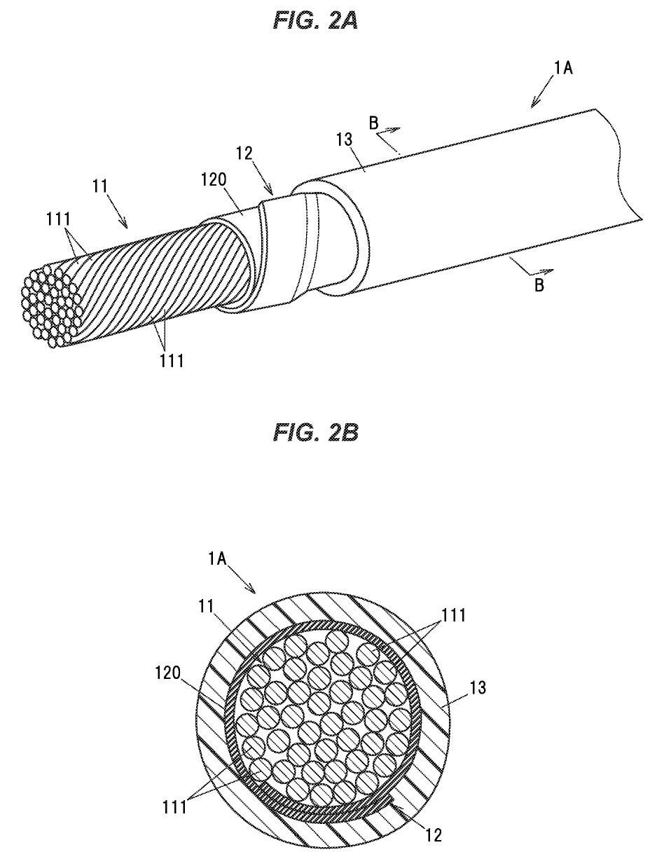

FIG. 2A is a perspective view showing the insulated wire 1A which is one of the three insulated wires 1A, 1B, 1C. FIG. 2B is a cross-sectional view showing the insulated wire 1A taken along line B-B in FIG. 2A. The insulated wires 1B and 1C also have the same configuration as the insulated wire 1A.

A conductor cross-sectional area of the conductor 11 is, e.g., 38 mm² or more. In the first embodiment, the conductor 11 is a stranded wire formed by twisting together plural copper strands 111. The copper strand 111 can be, e.g., a soft copper wire, a hard copper wire, or a tin-containing copper alloy wire. The conductor 11 has forty-three copper strands 111 in the example shown in FIGS. 2A and 2B, but the number of copper strands 111 is not limited thereto and the conductor 11 can be formed using an appropriate number of copper strands 111 according to the intended use, etc., of the cable 1.

The separator layer 12 is composed of a separator tape 120. The separator tape 120 has a strip shape and is spirally wrapped around the conductor 11. Alternatively, the separator tape 120 may be longitudinally wrapped along the longitudinal direction of the conductor 11. The separator tape 120 is made of a water-free fluoroplastic. Specifically, e.g., PTFE (polytetrafluoroethylene), PFA (perfluoroalkoxy alkane), or FEP (perfluoroethylene propylene copolymer) can be used as the fluoroplastic.

The insulation 13 is made of a fluorine rubber extruded on the outer circumference of the separator layer 12. Generally, fluorine rubber used as insulations of insulated wires contains trace amounts of water due to superheated steam, etc. used in the manufacturing process, but in the first embodiment, the water content of the insulations 13 after manufacturing the insulated wires 1A, 1B, 1C is lower than the water content of insulations of conventional fluorine rubber-insulated wires and is 0.1 wt% or more and 0.4 wt% or less. The method for manufacturing the insulated wires 1A, 1B, 1C, including the method of forming the insulation 13, will be described later. The water content of the insulation 13 can be measured using a Karl Fischer moisture analyzer or a halogen moisture analyzer.

When the manufactured insulated wires 1A, 1B, 1C are kept at 250°C for 96 hours in a thermal aging test and is then left in an environment with room temperature and a humidity of 50% for 24 hours, the insulations 13 have a water content of 0.2 wt% or more and 0.5 wt% or less. By leaving the insulated wires 1A, 1B, 1C in an environment with room temperature and a humidity of 50% for 24 hours, the insulations 13 absorb moisture and the water content of the insulations 13 thus increases.

When the elongation of the insulations 13 after manufacturing the insulated wires 1A, 1B, 1C but before conducting a thermal aging test is defined as E₁, and the elongation of the insulations 13 after keeping the insulated wires 1A, 1B, 1C at a temperature of 250°C for 96 to 672 hours in a thermal aging test and then leaving in an environment with room temperature and a humidity of 50% for 24 hours is defined as E₂, a value of E₂/E₁, which is a quotient obtained by dividing E₂ by E₁, is 0.65 or more. That is, whether the duration of keeping at a temperature of 250°C is 96 hours or 672 hours, the value of E₂/E₁, where E₂ is the elongation of the insulation 13 after subsequently leaving the insulated wires 1A, 1B, 1C in an environment with room temperature and a humidity of 50% for 24 hours, is 0.65 or more. The “elongation” here refers to the elongation at break, which is expressed as a percentage, representing the permanent elongation after breaking relative to the gauge length when the conductors 11 and the separator tapes 120 are removed from the insulated wires 1A, 1B, 1C and the insulations 13 are pulled in the longitudinal direction.

Furthermore, when the elongation of the insulation 13 after keeping at 250°C for 96 hours in a thermal aging test and then leaving in an environment with room temperature and a humidity of 50% for 24 hours is defined as E₃, a value of E₃/E₁ is desirably 0.80 or more, and the insulations 13 of the insulated wires 1A, 1B, 1C in the first embodiment satisfy this criterion (E₃/E₁ ≥ 0.80).

Next, a method for manufacturing the insulated wires 1A, 1B, 1C will be described. The method for manufacturing the insulated wires 1A, 1B, 1C includes an insulation forming step of forming the insulation 13 by extruding a rubber material around the conductor 11 and cross-linking the rubber material, and a drying step of drying the insulation 13 formed in the insulation forming step so that the insulation 13 has a water content of 0.4 wt% or less. The manufactured insulated wires 1A, 1B, 1C are then twisted together to form the cable core 100, the tape member 101 is wrapped around the cable core 100 and the outer circumference of the tape member 101 is covered with the sheath 102, thereby obtaining the cable 1.

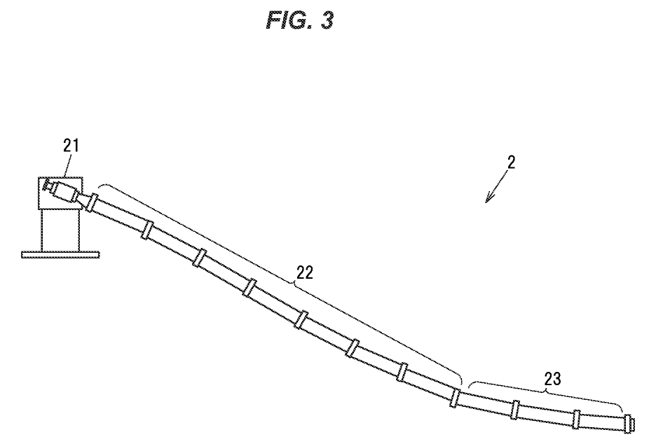

FIG. 3 is a schematic diagram illustrating an example configuration of a manufacturing device 2 used in the insulation forming step. The manufacturing device 2 has an extrusion molding device 21 to extrude a rubber material to be the fluorine rubber insulation 13, a cross-linking tube 22 to cross-link the extruded rubber material by heating, and a cooling tube 23 provided continuously from the cross-linking tube 22, and forms the insulation 13 that covers the conductor 11 together with the separator tape 120.

In the extrusion molding device 21, the conductor 11 covered with the separator tape 120 is continuously fed out, and the rubber material to be the insulation 13 is continuously extruded therearound. The conductor 11, the separator tape 120 and the rubber material fed from the extrusion molding device 21 are continuously supplied into the cross-linking tube 22. Superheated steam is supplied into the cross-linking tube 22, and the rubber material is heated and cross-linked by direct contact with the superheated steam. In the cooling tube 23, the cross-linked rubber material is cooled, e.g., with cooling water.

The temperature during the cross-linking in the manufacturing device 2 is, e.g., 190 ± 20°C. The separator tape 120 suppresses contact of the superheated steam with the conductor 11 and oxidation of the surfaces of the copper strands 111 due to heat. The water content of the insulations 13 of the insulated wires 1A, 1B, 1C immediately after being taken out of the manufacturing device 2 is, e.g., 0.45 ± 0.05%. The insulated wires 1A, 1B, 1C taken out of the manufacturing device 2 are sent to the drying step.

The drying step is performed using any of the following first to third methods. The first method involves drying in a hot air circulation drying furnace or room at 80°C or more for four days or more. The second method involves placing and drying in an airtight container, such as a desiccator, containing a desiccant such as silica gel. The third method involves vacuum drying using a constant-temperature oven with adjustable pressure. The drying step may be performed by a combination of these methods.

Hereinafter, the state of the insulation 13 at the completion of the drying step will be referred to as the initial state, the water content of the insulation 13 in the initial state will be referred to as the initial water content, and the elongation of the insulation 13 in the initial state (E₁ described above) will be referred to as the initial elongation. The initial elongation is, e.g., 395 (%). The initial water content is, e.g., 0.28 ± 0.05 wt%.

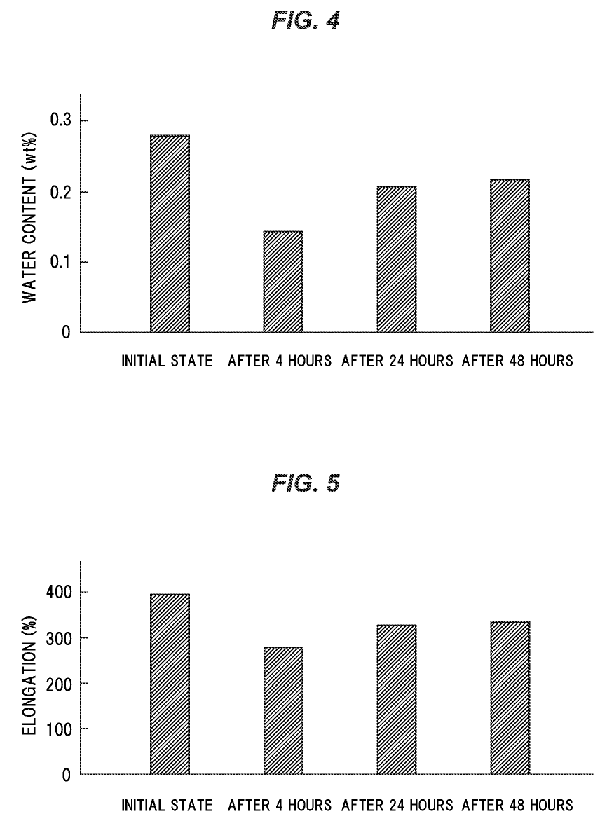

FIG. 4 is a graph showing the initial water content (the average value) of the insulations 13 of the insulated wires 1A, 1B, 1C, and changes in the water content (the average value) of the insulations 13 when the manufactured insulated wires 1A, 1B, 1C are kept at 250°C for 96 hours in a thermal aging test and are then left in an environment with room temperature and a humidity of 50% for 4 hours, 24 hours, and 48 hours. FIG. 5 is a graph showing the initial elongation (the average value) of the insulations 13 of the insulated wires 1A, 1B, 1C, and changes in the elongation (the average value) of the insulations 13 when the manufactured insulated wires 1A, 1B, 1C are kept at 250°C for 96 hours in a thermal aging test and are then left in an environment with room temperature and a humidity of 50% for 4 hours, 24 hours, and 48 hours.

As shown in FIG. 4, the water content of the insulations 13 decreases due to the thermal aging test and then increases by leaving in an environment with room temperature and a humidity of 50%. After 24 hours, the water content of the insulations 13 is substantially a constant value. Meanwhile, as shown in FIG. 5, the elongation of the insulations 13 decreases once due to the thermal aging test and then recovers by leaving in an environment with room temperature and a humidity of 50%, in a similar manner to the water content. After 24 hours, the elongation of the insulations 13 is substantially a constant value.

Here, if the initial water content of the insulations 13 is more than 0.4 wt%, ratios of the water content and elongation of the insulations 13 after the thermal aging test with respect to the initial water content and initial elongation increase, and the ratios of the elongation values of the insulations 13 after 4 hours, 24 hours, and 48 hours of the thermal aging test with respect to the initial elongation may fall below 0.8 or 0.65.

In contrast, in the first embodiment, by setting the initial water content to 0.4 wt% or less, the value of E₂/E₁ becomes 0.65 or more and also the value of E₃/E₁ becomes 0.8 or more, hence, the changes in the elongation of the insulations 13 after manufacturing the insulated wires 1A, 1B, 1C are suppressed. In other words, changes in the characteristics of the insulations 13 due to the surrounding environment after manufacturing can be suppressed, thereby stabilizing the characteristics of the insulation 13.

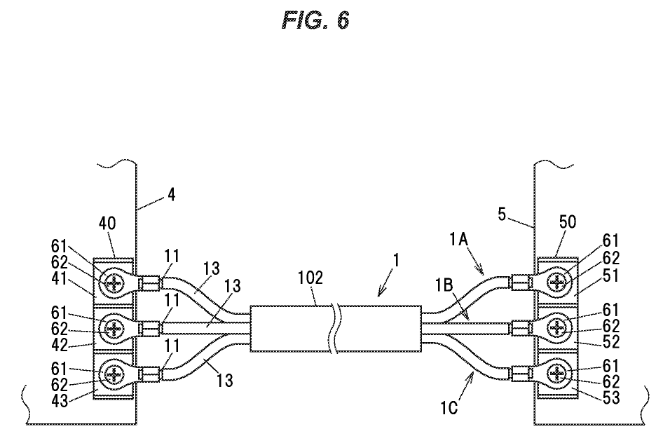

FIG. 6 is a configuration diagram illustrating an example of a connection structure connecting between a pair of devices 4, 5 using the insulated wires 1A, 1B, 1C. The devices 4 and 5 are, e.g., a motor, an inverter, a control device, an actuator, a transformer, and a power supply device, etc. The insulated wires 1A, 1B, 1C extend out of the sheath 102 at both ends in the longitudinal direction, and terminals 61 are respectively fitted to the ends of the insulated wires 1A, 1B, 1C.

The device 4 has a terminal block 40 with first to third washers 41 to 43. Likewise, the device 5 has a terminal block 50 with first to third washers 51 to 53. The insulated wire 1A connects the first washer 41 of the terminal block 40 of the device 4 to the first washer 51 of the terminal block 50 of the device 5. The insulated wire 1B connects the second washer 42 of the terminal block 40 of the device 4 to the second washer 52 of the terminal block 50 of the device 5. The insulated wire 1C connects the third washer 43 of the terminal block 40 of the device 4 to the third washer 53 of the terminal block 50 of the device 5. The plural terminals 61 are fixed to the terminal blocks 40, 50, respectively, by screws 62.

Next, the environment in which this connection structure is used will be described. One example of this environment is one where at least one of devices 4 and 5 is used in, e.g., a high-temperature environment of 60°C or more. Another example of this environment is one where insulated wires 1A, 1B, 1C are exposed to high temperatures, high radiation, high-temperature vapor, or immersion in cutting oil. Even when the insulated wires 1A, 1B, 1C of the first embodiment are used in such environments, the changes in the elongation of the insulations 13 are suppressed, which stabilizes the characteristics of the insulations 13.

FIG. 6 shows the example in which the terminals 61 are connected to the first to third washers 41 to 43, 51 to 53 of the terminal blocks 40, 50 of the devices 4, 5, but the configuration is not limited thereto and the conductors 11 of the insulated wires 1A, 1B, 1C may be connected to the devices 4, 5 by connectors. In this case, terminals of the connectors (connector terminals) are fitted to the tip portions of the conductors 11 of the insulated wires 1A, 1B, 1C.

### Second embodiment

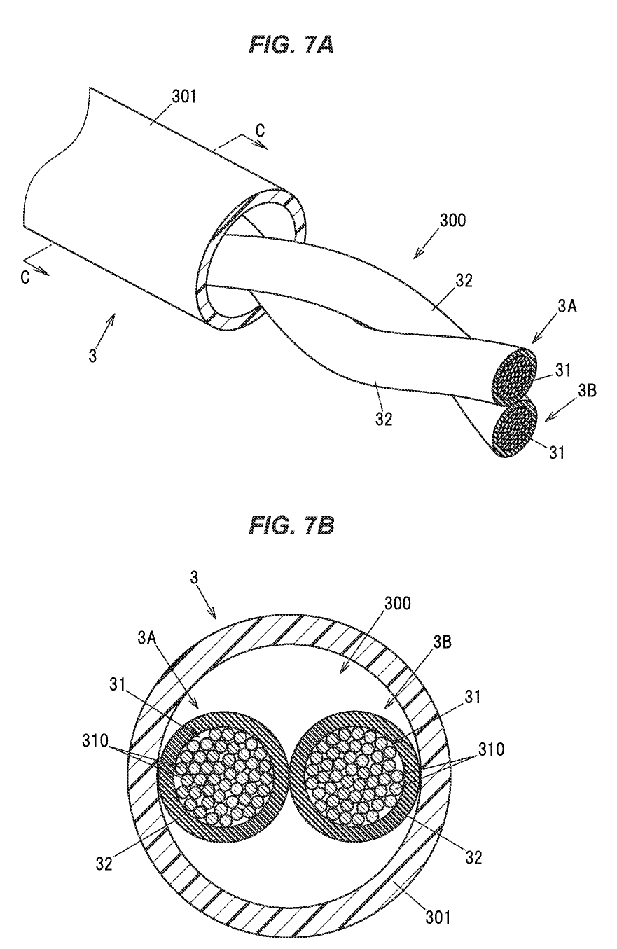

Next, the second embodiment of the invention will be described with reference to FIGS. 7A to 9. FIG. 7A is a perspective view showing a cable 3 in the second embodiment of the invention. FIG. 7B is a cross-sectional view showing the cable 3 taken along line C-C in FIG. 7A. This cable 3 is used, e.g., in a high-temperature environment such as vehicle engine compartment, in the same manner as the cable 1 in the first embodiment.

The cable 3 has a cable core 300 formed by twisting together plural insulated wires 3A, 3B, and a sheath 301 covering the cable core 300. The sheath 301 is made of, e.g., an ethylene-propylene copolymer and collectively covers the plural insulated wires 3A, 3B. In the second embodiment, the cable 3 has a pair of insulated wires 3A, 3B, which form a twisted pair. Additionally, a filler may be arranged around the insulated wires 3A, 3B.

The insulated wires 3A, 3B each include a conductor 31, and an insulation 32 that is made of a fluorine rubber and directly covers the conductor 31. The conductor 31 is a stranded wire formed by twisting together plural copper strands (plated copper wires) 310 with tin-plated or silver-plated surfaces. The conductor 31 has forty-seven copper strands 310 in the example shown in FIGS. 7A and 7B, but the number of copper strands 310 is not limited thereto and the conductor 31 can be formed using an appropriate number of copper strands 310 according to the intended use, etc., of the cable 3. A conductor cross-sectional area of the conductor 31 is, e.g., 5.5 mm² or less.

The insulated wires 3A, 3B are manufactured using a manufacturing method including the insulation forming step and the drying step and the insulations 32 are formed by the manufacturing device 2, in the same manner as the insulated wires 1A, 1B, 1C in the first embodiment. The water content (initial water content) and elongation (initial elongation) of the insulations 32 after manufacturing the insulated wires 3A, 3B are also the same as those of the insulations 13 in the first embodiment. Then, the insulations 32 have a water content of 0.2 wt% or more and 0.5 wt% or less after keeping at 250°C for 96 hours in a thermal aging test and then leaving the insulated wires 3A, 3B in an environment with room temperature and a humidity of 50% for 24 hours.

In the second embodiment, when the initial elongation of the insulations 32 is defined as E₁, and the elongation of the insulations 32 after keeping the manufactured insulated wires 3A, 3B at a temperature of 250°C for 96 to 672 hours in a thermal aging test and then leaving in an environment with room temperature and a humidity of 50% for 24 hours is defined as E₂, a value of E₂/E₁ is 0.65 or more. Then, when the elongation of the insulations 32 after keeping the manufactured insulated wires 3A, 3B at 250°C for 96 hours in a thermal aging test and then leaving in an environment with room temperature and a humidity of 50% for 24 hours is defined as E₃, a value of E₃/E₁ is 0.80 or more.

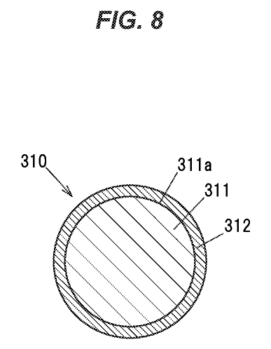

FIG. 8 is a cross-sectional view showing the copper strand 310. The copper strand 310 has a strand main body 311 formed of a soft copper wire, a hard copper wire, or a tin-containing copper alloy wire, and a plating layer 312 formed to cover a surface 311a of the strand main body 311. The plating layer 312 is a tin plating layer made of tin or a silver plating layer made of silver. The plating layer 312 prevents oxidation of the surface 311a of the strand main body 311 due to heat during cross-linking in the manufacturing process of the insulation 32.

Also in the second embodiment, the changes in the elongation of the insulations 32 after manufacturing the insulated wires 3A, 3B are suppressed and the changes in the characteristics of the insulations 32 due to the surrounding environment after manufacturing can be suppressed, in the same manner as the first embodiment.

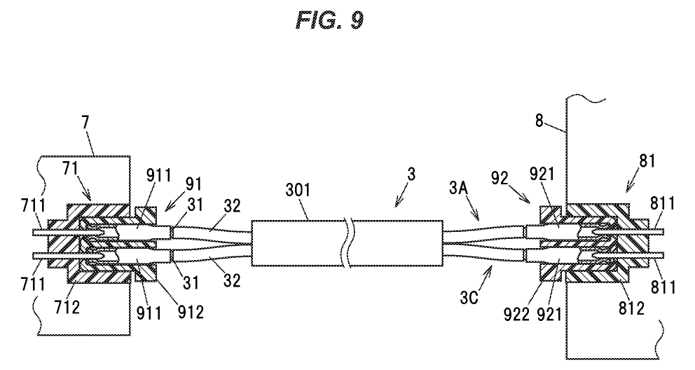

FIG. 9 is a configuration diagram illustrating an example of a connection structure connecting between a pair of devices 7, 8 using the insulated wires 3A, 3B. The devices 7, 8 are, e.g., an electronic device such as sensor, an actuator, or a control device. The insulated wires 3A, 3B extend out of the sheath 301 at both ends in the longitudinal direction, and terminals 911 are respectively fitted to the conductors 31 at one longitudinal end of the insulated wires 3A, 3B and are held by a connector housing 912. Terminals 921 are respectively fitted to the conductors 31 at the other longitudinal ends of the insulated wires 3A, 3B and are held by a connector housing 922.

The plural terminals 911 and the connector housing 912 constitute a first connector 91. The first connector 91 is fitted to a device-side connector 71 of the device 7, and the plural terminals 911 are respectively connected to terminals 711 of the connector 71. The device-side connector 71 has plural terminals 711 and a connector housing 712 holding the plural terminals 711.

The plural terminals 921 and the connector housing 922 constitute a second connector 92. The second connector 92 is fitted to a device-side connector 81 of the device 8, and the plural terminals 921 are respectively connected to terminals 811 of the connector 81. The device-side connector 81 has plural terminals 811 and a connector housing 812 holding the plural terminals 811.

An example of an environment in which this connection structure is used is an environment in which at least one of the devices 7, 8 is used in, e.g., a high-temperature environment of 60°C or more. Another example of such an environment is an environment in which the insulated wires 3A, 3B are laid in an environment with exposure to high temperature, high radiation, high-temperature vapor, or involving immersion in cutting oil. Even when the insulated wires 3A, 3B in the second embodiment are used in such environments, the changes in the elongation of the insulations 32 are suppressed, which stabilizes the characteristics of the insulations 32.

### Modification of the second embodiment

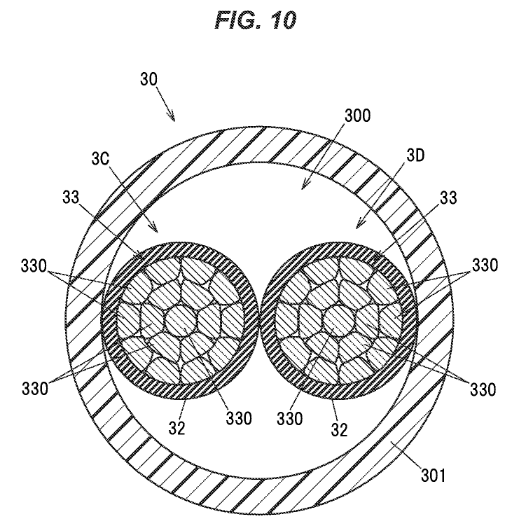

FIG. 10 is a cross-sectional view showing a cable 30 having insulated wires 3C, 3D with the conductor configuration changed from the conductor 31 of the insulated wire 3A, 3B of the cable 3 in the second embodiment. The insulated wires 3C, 3D are twisted together to form a cable core 302 and are collectively covered with the sheath 301. The insulated wires 3C, 3D are manufactured using the same manufacturing method as the insulated wires 1A, 1B, 1C in the first embodiment and the insulated wires 3A, 3B in the second embodiment, and the insulations 32 of the insulated wires 3C, 3D have the same characteristics as the insulations 32 of the insulated wires 3A, 3B in the second embodiment.

The conductors 33 of the insulated wires 3C, 3D are compressed stranded wires formed by twisting and compressing plural copper strands 330. A conductor cross-sectional area of the conductor 33 is, e.g., 5.5 mm² or less. In FIG. 10, as an example, the conductor 33 is composed of seventeen copper strands 330, with six copper strands 330 arranged to surround a single copper strand 330 located at the center, and ten copper strands 330 arranged to further surround the six copper strands 330. However, the number and arrangement of the copper strands 330 are not limited to those shown in FIG. 10 and can be appropriately changed according to the intended use, etc., of the cable 30.

In the insulated wires 3C, 3D in this modification, the plural copper strands 330 are compressed and are in tight contact with each other, which prevents superheated steam during the formation of the insulations 32 from getting to the centers of the conductors 33 through gaps between the plural copper strands 330. This suppresses oxidation of the surfaces of the copper strands 330 due to the heat of the superheated steam. The copper strand 330 may alternatively be a plated copper strand having a tin plating layer or a silver plating layer. In this case, since the copper strands 330 are compressed and have a plating layer, oxidation of the surfaces due to the heat of the superheated steam is suppressed more reliably.

### Summary of the embodiments

Technical ideas understood from the embodiments will be described below citing the reference signs, etc. used for the embodiments. However, each reference sign described below is not intended to limit the constituent elements in the claims to the members, etc., specifically described in the embodiments.

According to the first feature, an insulated wire 1A, 1B, 1C, 3A, 3B, 3C, 3D comprises: a conductor 11, 31, 33; and an insulation 13, 32 comprising a fluorine rubber and directly or indirectly covering the conductor 11, 31, 33, wherein the insulation 13, 32 has a water content of 0.4 wt% or less.

According to the second feature, in the insulated wire 1A, 1B, 1C, 3A, 3B, 3C, 3D as described in the first feature, the insulation 13, 32 has a water content of 0.2 wt% or more and 0.5 wt% or less after keeping at 250°C for 96 hours in a thermal aging test and then leaving in an environment with room temperature and a humidity of 50% for 24 hours

According to the third feature, in the insulated wire 1A, 1B, 1C, 3A, 3B, 3C, 3D as described in the first or second feature, a value of E₂/E₁ is 0.65 or more, where E₁ is an initial elongation of the insulation 13, 32 and E₂ is the elongation of the insulation 13, 32 after keeping at 250°C for 96 to 672 hours in a thermal aging test and then leaving in an environment with room temperature and a humidity of 50% for 24 hours.

According to the fourth feature, in the insulated wire 1A, 1B, 1C, 3A, 3B, 3C, 3D as described in the first or second feature, a value of E₃/E₁ is 0.80 or more, where E₁ is the initial elongation of the insulation 13, 32 and E₃ is the elongation of the insulation 13, 32 after keeping at 250°C for 96 hours in a thermal aging test and then leaving in an environment with room temperature and a humidity of 50% for 24 hours.

According to the fifth feature, in the insulated wire 3A, 3B as described in the first feature, the conductor 31 comprises a stranded wire comprising a plurality of tin-plated or silver-plated copper strands 310 twisted together.

According to the sixth feature, in the insulated wire 3C, 3D as described in the first or fifth feature, the conductor 33 comprises a compressed stranded wire comprising a plurality of copper strands 330 twisted together and compressed.

According to the seventh feature, in the insulated wire 1A, 1B, 1C as described in the first or fifth feature, a separator layer 12 comprising a fluoroplastic separator tape 120 is provided between the conductor 11 and the insulation 13.

According to the eighth feature, a cable 1, 3, 30 comprises: a plurality of insulated wires 1A, 1B, 1C, 3A, 3B, 3C, 3D collectively covered with a sheath 102, 301, the insulated wire 1A, 1B, 1C, 3A, 3B, 3C, 3D comprises a conductor 11, 31, 33, and an insulation 13, 32 comprising a fluorine rubber and directly or indirectly covering the conductor 11, 31, 33, and the insulation 13, 32 has a water content of 0.4 wt% or less.

According to the ninth feature, a method for manufacturing an insulated wire 1A, 1B, 1C, 3A, 3B, 3C, 3D that comprises a conductor 11, 31, 33 and an insulation 13, 32 comprising a fluorine rubber and directly or indirectly covering the conductor 11, 31, 33, the method comprises: forming the insulation 13, 32 by extruding a rubber material around the conductor 11, 31, 33 and cross-linking the rubber material; and drying the insulation 13, 32 formed in the forming the insulation 13, 32 so that the insulation 13, 32 has a water content of 0.4 wt% or less.

According to the tenth feature, a connection structure connects between a pair of devices 4, 5/7, 8 using the insulated wire 1A, 1B, 1C, 3A, 3B, 3C, 3D: wherein at least one of the pair of devices 4, 5/7, 8 is used in a high-temperature environment, a terminal 61, 911, 921 is fitted to the conductor 11, 31, 33 at an end of the insulated wire 1A, 1B, 1C, 3A, 3B, 3C, 3D, and the terminal 61, 911, 921 is connected to the at least one device.

According to the eleventh feature, a connection structure connects between a pair of devices 4, 5/7, 8 using the insulated wire 1A, 1B, 1C, 3A, 3B, 3C, 3D: wherein the insulated wire 1A, 1B, 1C, 3A, 3B, 3C, 3D is laid in an environment with exposure to high temperature, high radiation, high-temperature vapor, or involving immersion in cutting oil, a terminal 61, 911, 921 is fitted to the conductor 11, 31, 33 at an end of the insulated wire 1A, 1B, 1C, 3A, 3B, 3C, 3D, and the terminal 61, 911, 921 is connected to one of the pair of devices 4, 5/7, 8.

Although the embodiments of the invention have been described, the invention according to claims is not to be limited to the embodiments described above. Further, please note that not all combinations of the features described in the embodiments are necessary to solve the problem of the invention.

In addition, the invention can be appropriately modified and implemented without departing the gist thereof. For example, although the example in which the cable is formed by twisting together plural insulated wires has been described in the above embodiments, the insulated wires of the invention may be wired individually. In addition, although the example in which the initial water content of the insulations 13, 32 is 0.1 wt% or more and 0.4 wt% or less has been described in the above embodiments, the insulated wires 1A, 1B, 1C, 3A, 3B, 3C, and 3D may be manufactured so that the initial water content of the insulations 13, 32 is 0.1 wt% or more and 0.3 wt% or less. In this case, it is possible to further increase the value of E₂/E₁ and the value of E₃/E₁, thereby further enhancing the stability of the characteristics of insulations 13, 32.

1. An insulated wire, comprising:
a conductor; and
an insulation comprising a fluorine rubber and directly or indirectly covering the conductor,
wherein the insulation has a water content of 0.4 wt% or less.

2. The insulated wire according to claim 1, wherein the insulation has a water content of 0.2 wt% or more and 0.5 wt% or less after keeping at 250°C for 96 hours in a thermal aging test and then leaving in an environment with room temperature and a humidity of 50% for 24 hours.

3. The insulated wire according to claim 1, wherein a value of E₂/E₁ is 0.65 or more, where E₁ is an initial elongation of the insulation and E₂ is an elongation of the insulation after keeping at 250°C for 96 to 672 hours in a thermal aging test and then leaving in an environment with room temperature and a humidity of 50% for 24 hours.

4. The insulated wire according to claim 2, wherein a value of E₂/E₁ is 0.65 or more, where E₁ is an initial elongation of the insulation and E₂ is an elongation of the insulation after keeping at 250°C for 96 to 672 hours in a thermal aging test and then leaving in an environment with room temperature and a humidity of 50% for 24 hours.

5. The insulated wire according to claim 1, wherein a value of E₃/E₁ is 0.80 or more, where E₁ is an initial elongation of the insulation and E₃ is an elongation of the insulation after keeping at 250°C for 96 hours in a thermal aging test and then leaving in an environment with room temperature and a humidity of 50% for 24 hours.

6. The insulated wire according to claim 2, wherein a value of E₃/E₁ is 0.80 or more, where E₁ is an initial elongation of the insulation and E₃ is an elongation of the insulation after keeping at 250°C for 96 hours in a thermal aging test and then leaving in an environment with room temperature and a humidity of 50% for 24 hours.

7. The insulated wire according to claim 1, wherein the conductor comprises a stranded wire comprising a plurality of tin-plated or silver-plated copper strands twisted together.

8. The insulated wire according to claim 1, wherein the conductor comprises a compressed stranded wire comprising a plurality of copper strands twisted together and compressed.

9. The insulated wire according to claim 8, wherein the conductor comprises a compressed stranded wire comprising a plurality of copper strands twisted together and compressed.

10. The insulated wire according to claim 1, wherein a separator layer comprising a fluoroplastic separator tape is provided between the conductor and the insulation.

11. The insulated wire according to claim 8, wherein a separator layer comprising a fluoroplastic separator tape is provided between the conductor and the insulation.

12. A cable, comprising:
a plurality of insulated wires collectively covered with a sheath,
wherein the insulated wire comprises a conductor, and an insulation comprising a fluorine rubber and directly or indirectly covering the conductor, and
wherein the insulation has a water content of 0.4 wt% or less.

13. A method for manufacturing an insulated wire that comprises a conductor and an insulation comprising a fluorine rubber and directly or indirectly covering the conductor, the method comprising:
forming the insulation by extruding a rubber material around the conductor and cross-linking the rubber material; and
drying the insulation formed in the forming the insulation so that the insulation has a water content of 0.4 wt% or less.

14. A connection structure to connect between a pair of devices using the insulated wire according to claim 1,
wherein at least one of the pair of devices is used in a high-temperature environment,
wherein a terminal is fitted to the conductor at an end of the insulated wire, and
wherein the terminal is connected to the at least one device.

15. A connection structure to connect between a pair of devices using the insulated wire according to claim 1,
wherein the insulated wire is laid in an environment with exposure to high temperature, high radiation, high-temperature vapor, or involving immersion in cutting oil,
wherein a terminal is fitted to the conductor at an end of the insulated wire, and
wherein the terminal is connected to one of the pair of devices.
